(19) United States
(12) Patent Application Publication
(10) Pub. No.: US 2016/0217794 A1
(43) Pub. Date: Jul. 28, 2016

(54) INFORMATION PROCESSING APPARATUS, INFORMATION PROCESSING METHOD, AND PROGRAM

(71) Applicant: SONY CORPORATION, Minato-ku, Tokyo (JP)

(72) Inventors: Maki IMOTO, Tokyo (JP); Takuro NODA, Tokyo (JP); Ryouhei YASUDA, Kanagawa (JP)

(73) Assignee: Sony Corporation, Tokyo (JP)

(21) Appl. No.: 14/916,899

(22) PCT Filed: Jul. 25, 2014
(86) PCT No.: PCT/JP2014/003947

§ 371 Date: Mar. 4, 2016

(30) Foreign Application Priority Data
Sep. 11, 2013 (JP) 2013-188220

(51) Int. Cl. G10L 17/22; G06F 3/01; G06F 3/16

(52) U.S. Cl. CPC G10L 17/22; G06F 3/167; G06F 3/013

(57) ABSTRACT

There is provided an information processing apparatus including a circuitry configured to initiate a voice recognition upon a determination that a user gaze has been made towards a first region within which a display object is displayed, and
initiate an execution of a process based on the voice recognition.

### CROSS REFERENCE TO RELATED APPLICATIONS

This application claims the benefit of Japanese Priority Patent Application JP 2013-188220 filed Sep. 11, 2013, the entire contents of which are incorporated herein by reference.

### TECHNICAL FIELD

The present disclosure relates to an information processing apparatus, an information processing method, and a program.

### BACKGROUND ART

In recent years, user interfaces allowing a user to operate through the line of sight by using line-of-sight detection technology such as an eye tracking technology are emerging. For example, the technology described in PTL 1 below can be cited as a technology concerning the user interface allowing the user to operate through the line of sight.

### CITATION LIST

### Patent Literature

PTL 1: JP 2009-64395A

### SUMMARY

### Technical Problem

When voice recognition is performed, for example, a specific user operation being performed by the user such as pressing a button or a specific word being uttered by the user can be considered as a trigger to start the voice recognition. However, when voice recognition is performed by a specific user operation or utterance of a specific word as described above, the operation or a conversation the user is engaged in may be prevented. Thus, when voice recognition is performed by a specific user operation or utterance of a specific word as described above, the convenience of the user may be degraded.

The present disclosure proposes a novel and improved information processing apparatus capable of enhancing the convenience of the user when voice recognition is performed, an information processing method, and a program.

### Solution to Problem

According to an aspect of the present disclosure, there is provided an information processing apparatus including a circuitry configured to: initiate a voice recognition upon a determination that a user gaze has been made towards a first region within which a display object is displayed; and initiate an execution of a process based on the voice recognition.

According to another aspect of the present disclosure, there is provided an information processing method including: initiating a voice recognition upon a determination that a user gaze has been made towards a first region within which a display object is displayed; and executing a process based on the voice recognition.

According to another aspect of the present disclosure, there is provided a non-transitory computer-readable medium having embodied thereon a program, which when executed by a computer causes the computer to perform a method, the method including: initiating a voice recognition upon a determination that a user gaze has been made towards a first region within which a display object is displayed; and executing a process based on the voice recognition.

### Advantageous Effects of Invention

According to the present disclosure, the convenience of the user when voice recognition is performed can be enhanced.

The above effect is not necessarily restrictive and together with the above effect or instead of the above effect, one of the effects shown in this specification or another effect grasped from this specification may be achieved.

### BRIEF DESCRIPTION OF DRAWINGS

FIG. 1 is an explanatory view showing examples of a predetermined object according to an embodiment.

FIG. 2 is an explanatory view illustrating an example of processing according to an information processing method according to an embodiment.

FIG. 3 is an explanatory view illustrating an example of processing according to the information processing method according to an embodiment.

FIG. 4 is an explanatory view illustrating an example of processing according to the information processing method according to an embodiment.

FIG. 5 is an explanatory view illustrating an example of processing according to the information processing method according to an embodiment.

FIG. 6 is an explanatory view illustrating an example of processing according to the information processing method according to an embodiment.

FIG. 7 is an explanatory view illustrating an example of processing according to the information processing method according to an embodiment.

FIG. 8 is a block diagram showing an example of the configuration of an information processing apparatus according to an embodiment.

FIG. 9 is an explanatory view showing an example of a hardware configuration of the information processing apparatus according to an embodiment.

### DESCRIPTION OF EMBODIMENTS

Embodiments of the present disclosure will be described in detail below with reference to the appended drawings. Note that in this specification and the drawings, the same reference signs are attached to elements having substantially the same function and configuration, thereby omitting duplicate descriptions.

The description will be provided in the order shown below:

1. Information Processing Method According to an Embodiment

2. Information Processing Apparatus According to an Embodiment

3. Program According to an Embodiment

### Information Processing Method According to an Embodiment

Before describing the configuration of an information processing apparatus according to an embodiment, an information processing method according to an embodiment will first be described. The information processing method according to an embodiment will be described by taking a case in which processing according to the information processing method according to an embodiment is performed by an information processing apparatus according to an embodiment as an example.

### 1. Overview of Processing According to the Information Processing Method According to an Embodiment

As described above, when voice recognition is performed by a specific user operation or utterance of a specific word, the convenience of the user may be degraded. When a specific user operation or utterance of a specific word is used as a trigger to start voice recognition, another operation or a conversation the user is engaged in may be prevented and thus, a specific user operation or utterance of a specific word can hardly be considered to be a natural operation.

Thus, an information processing apparatus according to an embodiment controls voice recognition processing to cause voice recognition not only when a specific user operation or utterance of a specific word is detected, but also when it is determined that the user has viewed a predetermined object displayed on the display screen.

As the target for control of voice recognition processing by the information processing apparatus according to an embodiment, for example, the local apparatus (information processing apparatus according to an embodiment. This also applies below) and an external apparatus capable of communication via a communication unit (described later) or a connected external communication device can be cited. As the external apparatus, for example, any apparatus capable of performing voice recognition processing such as a server can be cited. The external apparatus may also be a system including one or two or more apparatuses predicated on connection to a network (or communication between apparatuses) like cloud computing.

When the target for control of voice recognition processing is the local apparatus, for example, the information processing apparatus according to an embodiment performs voice recognition (voice recognition processing) in the local apparatus and uses results of voice recognition performed in the local apparatus. The information processing apparatus according to an embodiment recognizes voice by using, for example, any technology capable of recognizing voice.

When the target for control of voice recognition processing is the external apparatus, the information processing apparatus according to an embodiment causes a communication unit (described later) or the like to transmit, for example, control data containing instructions controlling voice recognition to the external apparatus. Instructions controlling voice recognition according to an embodiment include, for example, an instruction causing the external apparatus to perform voice recognition processing and an instruction causing the external apparatus to terminate the voice recognition processing. The control data may further include, for example, a voice signal showing voice uttered by the user. When the communication unit is caused to transmit the control data containing the instruction causing the external apparatus to perform voice recognition processing to the external apparatus, the information processing apparatus according to an embodiment uses, for example, “data showing results of voice recognition performed by the external apparatus” acquired from the external apparatus.

The processing according to the information processing method according to an embodiment will be described below by mainly taking a case in which the target for control of voice recognition processing by the information processing apparatus according to an embodiment is the local apparatus, that is, the information processing apparatus according to an embodiment performs voice recognition as an example.

The display screen according to an embodiment is, for example, a display screen on which various images are displayed and toward which the user directs the line of sight.

As the display screen according to an embodiment, for example, the display screen of a display unit (described later) included in the information processing apparatus according to an embodiment and the display screen of an external display apparatus (or an external display device) connected to the information processing apparatus according to an embodiment wirelessly or via a cable can be cited.

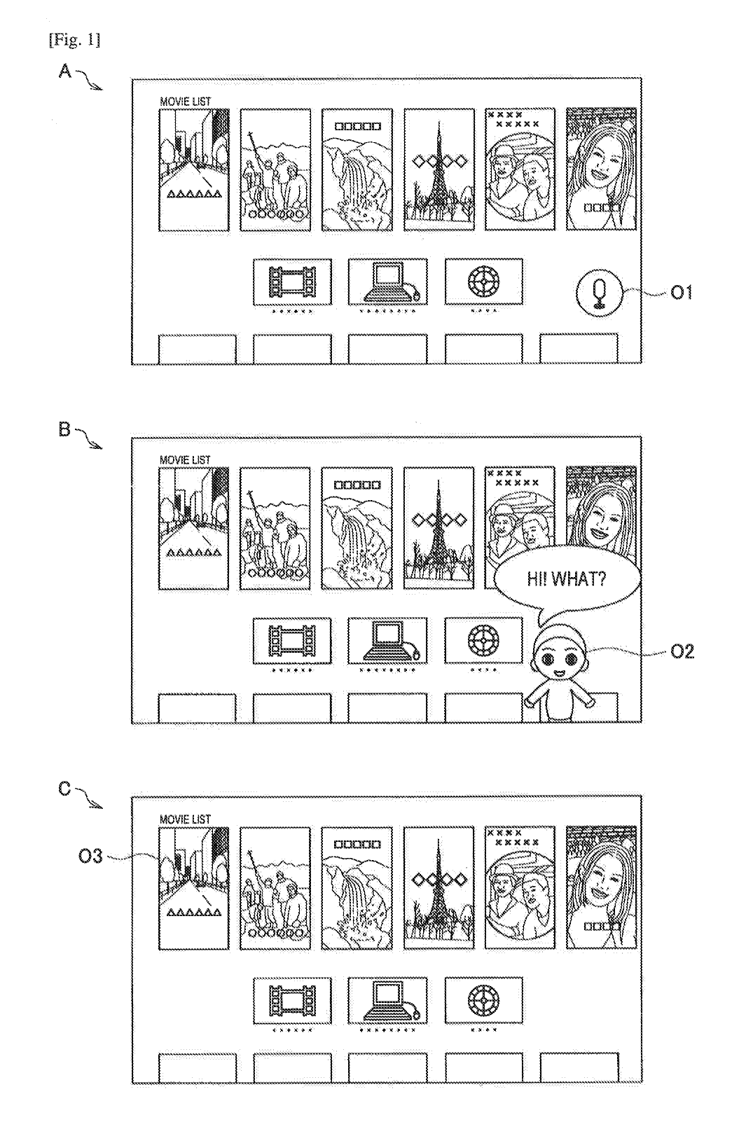

FIG. 1 is an explanatory view showing examples of a predetermined object according to an embodiment. A of FIG. 1 to C of FIG. 1 each show examples of images displayed on the display screen and containing a predetermined object.

As the predetermined object according to an embodiment, for example, an icon (hereinafter, called a “voice recognition icon”) to cause voice recognition as indicated by O1 in A of FIG. 1 and an image (hereinafter, called a “voice recognition image”) to cause voice recognition as indicated by O2 in B of FIG. 1 can be cited. In the example shown in B of FIG. 1, a character image showing a character is shown as a voice recognition image according to an embodiment. It is needless to say that the voice recognition icon and the voice recognition image according to an embodiment are not limited to the examples shown in A of FIG. 1 and B of FIG. 1 respectively.

Predetermined objects according to an embodiment are not limited to the voice recognition icon and the voice recognition image. For example, the predetermined object according to an embodiment may be, for example, like an object indicated by O3 in C of FIG. 1, an object (hereinafter, called a “selection candidate object”) that can be selected by a user operation. In the example shown in C of FIG. 1, a thumbnail image showing the title of a movie or the like is shown as a selection candidate object according to an embodiment. In C of FIG. 1, a thumbnail image or an icon to which reference sign O3 is attached may be a selection candidate object according to an embodiment. It is needless to say that the selection candidate object according to an embodiment is not limited to the example shown in C of FIG. 1.

If voice recognition is performed by the information processing apparatus according to an embodiment when it is determined that the user has viewed a predetermined object as shown in FIG. 1 displayed on the display screen, the user can cause the information processing apparatus according to an embodiment to start voice recognition by, for example, viewing the predetermined object by directing the line of sight toward the predetermined object.

Even if the user should be engaged in another operation or a conversation, the possibility that the other operation or the conversation is prevented by a predetermined object being viewed by the user is lower than when voice recognition is performed by a specific user operation or utterance of a specific word.

Further, when a predetermined object displayed on the display screen being viewed by the user is used as a trigger to start voice recognition, the possibility that another operation or a conversation the user is engaged in is prevented is low and thus, a predetermined object displayed on the display screen being viewed by the user is considered to be an operation more natural than the specific user operation or utterance of the specific word.

Therefore, the convenience of the user when voice recognition is performed can be enhanced by the information processing apparatus according to an embodiment being caused to perform voice recognition as processing according to the information processing method according to an embodiment when it is determined that the user has viewed a predetermined object displayed on the display screen.

### 2. Processing According to the Information Processing Method According to an Embodiment

Next, the processing according to the information processing method according to an embodiment will be described more concretely.

The information processing apparatus according to an embodiment enhances the convenience of the user by performing, for example, (1) Determination processing and (2) Voice recognition processing described below as the processing according to the information processing method according to an embodiment.

(1) Determination Processing

The information processing apparatus according to an embodiment determines whether the user has viewed a predetermined object based on, for example, information about the position of the line of sight of the user on the display screen.

Here, the information about the position of the line of sight of the user according to an embodiment is, for example, data showing the position of the line of sight of the user or data that can be used to identify the position of the line of sight of the user (or data that can be used to estimate the position of the line of sight of the user. This also applies below).

As the data showing the position of the line of sight of the user according to an embodiment, for example, coordinate data showing the position of the line of sight of the user on the display screen can be cited. The position of the line of sight of the user on the display screen is represented by, for example, coordinates in a coordinate system in which a reference position of the display screen is set as its origin. The data showing the position of the line of sight of the user according to an embodiment may include the data indicating the direction of the line of sight (for example, the data showing the angle with the display screen).

As the data that can be used to identify the position of the line of sight of the user according to an embodiment, for example, captured image data in which the direction in which images (moving images or still images) are displayed on the display screen is imaged can be cited. The data that can be used to identify the position of the line of sight of the user according to an embodiment may further include detection data of any sensor obtaining detection values that can be used to improve estimation accuracy of the position of the line of sight of the user such as detection data of an infrared sensor that detects infrared radiation in the direction in which images are displayed on the display screen.

When coordinate data indicating the position of the line of sight of the user on the display screen is used as information about the position of the line of sight of the user according to an embodiment, the information processing apparatus according to an embodiment identifies the position of the line of sight of the user on the display screen by using, for example, coordinate data acquired from an external apparatus having identified (estimated) the position of the line of sight of the user by using the line-of-sight detection technology and indicating the position of the line of sight of the user on the display screen. When the data indicating the direction of the line of sight is used as information about the position of the line of sight of the user according to an embodiment, the information processing apparatus according to an embodiment identifies the direction of the line of sight by using, for example, data indicating the direction of the line of sight acquired from the external apparatus.

It is possible to identify the position of the line of sight of the user and the direction of the line of sight of the user on the display screen by using the line of sight detected by using the line-of-sight detection technology and the position of the user and the orientation of face with respect to the display screen detected from a captured image in which the direction in which images are displayed on the display screen is captured. However, the method of identifying the position of the line of sight of the user and the direction of the line of sight of the user on the display screen according to an embodiment is not limited to the above method. For example, the information processing apparatus according to an embodiment and the external apparatus can use any technology capable of identifying the position of the line of sight of the user and the direction of the line of sight of the user on the display screen.

As the line-of-sight detection technology according to an embodiment, for example, a method of detecting the line of sight based on the position of a moving point (for example, a point corresponding to a moving portion in an eye such as the iris and the pupil) of an eye with respect to a reference point (for example, a point corresponding to a portion that does not move in the eye such as an eye's inner corner or corneal reflex) of the eye can be cited. However, the line-of-sight detection technology according to an embodiment is not limited to the above technology and may be, for example, any line-of-sight detection technology capable of detecting the line of sight.

When data that can be used to identify the position of the line of sight of the user is used as information about the position of the line of sight of the user according to an embodiment, the information processing apparatus according to an embodiment uses, for example, captured image data (example of data that can be used to identify the position of the line of sight of the user) acquired by an imaging unit (described later) included in the local apparatus or an external imaging device. In the above case, the information processing apparatus according to an embodiment may use, for example, detection data (example of data that can be used to identify the position of the line of sight of the user) acquired from a sensor that can be used to improve estimation accuracy of the position of the line of sight of the user included in the local apparatus or an external sensor. The information processing apparatus according to an embodiment performs processing according to an identification method of the position of the line of sight of the user and the direction of the line of sight of the user on the display screen according to an embodiment using, for example, data that can be used to identify the position of the line of sight of the user acquired as described above to identify the position of the line of sight of the user and the direction of the line of sight of the user on the display screen.

(1-1) First Example of the Determination Processing

When, for example, the position of the line of sight indicated by information about the position of the line of sight of the user is contained in a first region of the display screen containing a predetermined object, the information processing apparatus according to an embodiment determines that the user has viewed the predetermined object.

The first region according to an embodiment is set based on a reference position of the predetermined object. As the reference position according to an embodiment, for example, any preset position in an object such as a center point of the object can be cited. The size and shape of the first region according to an embodiment may be set in advance or based on a user operation. As an example, for example, the minimum region of regions containing a predetermined object (that is, regions in which the predetermined object is displayed), a circular region around a reference point of a predetermined object and a rectangular region can be cited as the first region according to an embodiment. The first region according to an embodiment may also be, for example, a region (hereinafter, presented as a “divided region”) obtained by dividing a display region of the display screen.

More specifically, the information processing apparatus according to an embodiment determines that the user has viewed a predetermined object when the position of the line of sight indicated by information about the position of the line of sight of the user is contained inside the first region of the display screen containing the predetermined object.

However, the determination processing according to the first example is not limited to the above processing.

For example, the information processing apparatus according to an embodiment may determine that the user has viewed a predetermined object when the time in which the position of the line of sight indicated by information about the position of the line of sight of the user is within the first region is longer than a set first setting time. Also, the information processing apparatus according to an embodiment may determine that the user has viewed a predetermined object when the time in which the position of the line of sight indicated by information about the position of the line of sight of the user is within the first region is equal to the set first setting time or longer.

As the first setting time according to an embodiment, for example, a preset time based on an operation of the manufacturer of the information processing apparatus according to an embodiment or the user can be cited. When the first setting time according to an embodiment is a preset time, the information processing apparatus according to an embodiment determines whether the user has viewed a predetermined object based on the time in which the position of the line of sight indicated by information about the position of the line of sight of the user is within the first region and the preset first setting time.

The information processing apparatus according to an embodiment determines whether the user has viewed a predetermined object based on information about the position of the line of sight of the user by performing, for example, the determination processing according to the first example.

As described above, when it is determined that the user has viewed a predetermined object displayed on the display screen, the information processing apparatus according to an embodiment causes voice recognition. That is, when it is determined that the user has viewed a predetermined object as a result of performing, for example, the determination processing according to the first example, the information processing apparatus according to an embodiment causes voice recognition by starting processing (voice recognition control processing) in (2) described later.

The determination processing according to an embodiment is not limited to, like the determination processing according to the first example, the processing that determines whether the user has viewed a predetermined object.

For example, after it is determined that the user has viewed a predetermined object based on information about the position of the line of sight of the user, the information processing apparatus according to an embodiment determines that the user does not view the predetermined object. When, after it is determined that the user has viewed a predetermined object based on information about the position of the line of sight of the user, determination processing according to a second example determines that the user does not view the predetermined object, the processing (voice recognition control processing) in (2) described later terminates the voice recognition of the user.

More specifically, when it is determined that the user has viewed a predetermined object, the information processing apparatus according to an embodiment determines that the user does not view the predetermined object by performing, for example, the determination processing according to the second example described below or determination processing according to a third example described below.

(1-2) Second Example of the Determination Processing

The information processing apparatus according to an embodiment determines that the user does not view a predetermined object when, for example, the position of the line of sight of the user corresponding to the user determined to have viewed the predetermined object is no longer contained in a second region of the display screen containing the predetermined object.

As the second region according to an embodiment, for example, the same region as the first region according to an embodiment can be cited. However, the second region according to an embodiment is not limited to the above example. For example, the second region according to an embodiment may be a region larger than the first region according to an embodiment.

As an example, for example, the minimum region of regions containing a predetermined object (that is, regions in which the predetermined object is displayed), a circular region around the reference point of a predetermined object and a rectangular region can be cited as the second region according to an embodiment. Also, the second region according to an embodiment may be a divided region. Concrete examples of the second region according to an embodiment will be described later.

If, for example, the first region according to an embodiment and the second region according to an embodiment are both the minimum region of regions containing a predetermined object (that is, regions in which the predetermined object is displayed), the information processing apparatus according to an embodiment determines that the user does not view the predetermined object when the user turns his (her) eyes away from the predetermined object. Then, the information processing apparatus according to an embodiment causes the processing (voice recognition control processing) in (2) to terminate the voice recognition of the user.

When, for example, the second region according to an embodiment is a region larger than the minimum region, the information processing apparatus according to an embodiment determines that the user does not view the predetermined object when the user turns his (her) eyes away from the second region. Then, the information processing apparatus according to an embodiment causes the processing (voice recognition control processing) in (2) to terminate the voice recognition of the user.

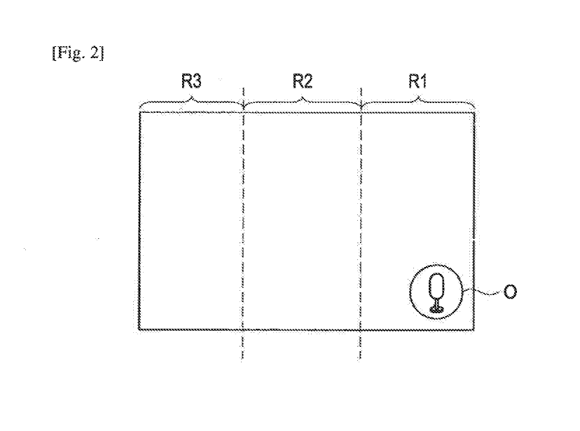

FIG. 2 is an explanatory view illustrating an example of processing according to an information processing method according to an embodiment. FIG. 2 shows an example of an image displayed on the display screen. In FIG. 2, a predetermined object according to an embodiment is represented by reference sign O and shows an example in which the predetermined object is a voice recognition icon. Hereinafter, the predetermined object according to an embodiment may be presented as a “predetermined object O”. Regions R1 to R3 shown in FIG. 2 are regions obtained by dividing the display region of the display screen into three regions and correspond to divided regions according to an embodiment.

When, for example, the second region according to an embodiment is the divided region R1, the information processing apparatus according to an embodiment determines that the user does not view the predetermined object O1 when the user turns his (her) eyes away from the divided region R1. Then, the information processing apparatus according to an embodiment causes the processing (voice recognition control processing) in (2) to terminate the voice recognition of the user.

The information processing apparatus according to an embodiment determines that the user does not view the predetermined object O1 based on the set second region like, for example, the divided region R1 shown in FIG. 2. It is needless to say that the second region according to an embodiment is not limited to the example shown in FIG. 2.

(1-3) Third Example of the Determination Processing

If, for example, a state in which the position of the line of sight indicated by information about the position of the line of sight of the user corresponding to the user determined to have viewed a predetermined object is not contained in a predetermined region continues for a set second setting time or longer, the information processing apparatus according to an embodiment determines that the user does not view the predetermined object. The information processing apparatus according to an embodiment may also determine that the user does not view the predetermined object if, for example, a state in which the position of the line of sight indicated by information about the position of the line of sight of the user corresponding to the user determined to have viewed a predetermined object is not contained in a predetermined region continues longer than the set second setting time.

As the second setting time according to an embodiment, for example, a preset time based on an operation of the manufacturer of the information processing apparatus according to an embodiment or the user can be cited. When the second setting time according to an embodiment is a preset time, the information processing apparatus according to an embodiment determines that the user does not view a predetermined object based on the time that has passed after the position of the line of sight indicated by information about the position of the line of sight of the user is not contained in the second region and the preset second setting time.

However, the second setting time according to an embodiment is not limited to a preset time.

For example, the information processing apparatus according to an embodiment can dynamically set the second setting time based on a history of the position of the line of sight indicated by information about the position of the line of sight of the user corresponding to the user determined to have viewed a predetermined object.

The information processing apparatus according to an embodiment sequentially records, for example, information about the position of the line of sight of the user in a recording medium such as a storage unit (described later) and an external recording medium. Also, the information processing apparatus according to an embodiment may delete information about the position of the line of sight of the user for which a set predetermined time has passed after the information being stored in the recording medium from the recording medium.

Then, the information processing apparatus according to an embodiment dynamically sets the second setting time using information about the position of the line of sight of the user (that is, information about the position of the line of sight of the user showing a history of the position of the line of sight of the user. Hereinafter, presented as “history information”) sequentially recorded in the recording medium.

For example, if history information in which the distance between the position of the line of sight of the user indicated by the history information and a boundary portion of the second region is equal to a set predetermined distance or less is present in the history information, the information processing apparatus according to an embodiment increases the second setting time. Also, the information processing apparatus according to an embodiment may increase the second setting time if history information in which the distance between the position of the line of sight of the user indicated by the history information and the boundary portion of the second region is less than the set predetermined distance is present in the history information.

The information processing apparatus according to an embodiment increases the second setting time by, for example, a set fixed time. The information processing apparatus according to an embodiment may change the time by which the second setting time is increased in accordance with the number of pieces of data of history information in which the distance is equal to the above distance or less (or history information in which the distance is less than the above distance).

The information processing apparatus according to an embodiment can consider hysteresis when determining that the user does not view a predetermined object by the second setting time being dynamically set, for example, as described above.

However, the determination processing according to an embodiment is not limited to the determination processing according to the first example to the determination processing according to the third example.

(1-4) Fourth Example of the Determination Processing

If, for example, after it is determined that one user has viewed a predetermined object, it is not determined that the one user does not view the predetermined object, the information processing apparatus according to an embodiment does not determine that another user has viewed the predetermined object.

When, for example, the processing (voice recognition control processing) in (2) described later is caused to perform voice recognition, if instructions by voice to perform processing are instructions concerning a device operation, it is desirable that the number of instructions by voice received at a time is one. This is because if there is a plurality of instructions by voice to be received at a time, for example, there is a possibility of inviting degradation of the convenience of the user by, for example, mutually contradictory instructions being successively performed.

Even if another user should have viewed a predetermined object, it is not determined that the other user has viewed the predetermined object by the determination processing according to the fourth example being performed by the information processing apparatus according to an embodiment and therefore, a situation that could invite the degradation of the convenience of the user as described above can be prevented.

(1-5) Fifth Example of the Determination Processing

The information processing apparatus according to an embodiment may determine whether the user has viewed a predetermined object based on, after a user is identified, information about the position of the line of sight of the user corresponding to the identified user.

The information processing apparatus according to an embodiment identifies the user based on, for example, a captured image in which the direction in which the image is displayed on the display screen is captured. More specifically, while the information processing apparatus according to an embodiment identifies the user by performing, for example, face recognition processing on a captured image, the method of identify the user is not limited to the above method.

When the user is identified, for example, the information processing apparatus according to an embodiment recognizes the user ID corresponding to the identified user and performs processing similar to the determination processing according to the first example based on information about the position of the line of sight of the user corresponding to the recognized user ID.

(2) Voice Recognition Control Processing

When, for example, it is determined in the processing (determination processing) in (1) that the user has viewed a predetermined object, the information processing apparatus according to an embodiment causes voice recognition by controlling voice recognition processing.

More specifically, as shown, for example, in voice recognition control processing according to a first example or voice recognition control processing according to a second example shown below, the information processing apparatus according to an embodiment causes voice recognition by using sound source separation or sound source localization. The sound source separation according to an embodiment is a technology that extracts only intended voice from various kinds of sound. The sound source localization according to an embodiment is a technology that measures the position (angle) of a sound source.

(2-1) First Example of the Voice Recognition Control Processing: When the Sound Source Separation is Used

The information processing apparatus according to an embodiment causes voice recognition in cooperation with a voice input device capable of performing sound source separation. The voice input device capable of performing sound source separation according to an embodiment may be, for example, a voice input device included in the information processing apparatus according to an embodiment or a voice input device outside the information processing apparatus according to an embodiment.

The information processing apparatus according to an embodiment causes a voice input device capable of performing sound source separation to acquire a voice signal showing voice uttered by the user determined to have viewed a predetermined object based on, for example, information about the position of the line of sight of the user corresponding to the user determined to have viewed the predetermined object. Then, the information processing apparatus according to an embodiment causes voice recognition of the voice signal acquired by the voice input device.

The information processing apparatus according to an embodiment calculates the orientation (for example, the angle of the line of sight with the display screen) of the user based on information about the position of the line of sight of the user corresponding to the user determined to have viewed a predetermined object. When information about the position of the line of sight of the user contains data showing the direction of the line of sight, the information processing apparatus according to an embodiment uses the orientation of the line of sight of the user indicated by the data showing the direction of the line of sight. Then, the information processing apparatus according to an embodiment transmits control instructions to cause a voice input device capable of performing sound source separation to perform sound source separation in the orientation of the line of sight of the user obtained by calculation or the like to the voice input device. By performing sound source separation according to the control instructions, the voice input device acquires a voice signal showing voice uttered by the position of the user determined to have viewed a predetermined object. It is needless to say that the method of acquiring a voice signal by a voice input device capable of performing sound source separation according to an embodiment is not limited to the above method.

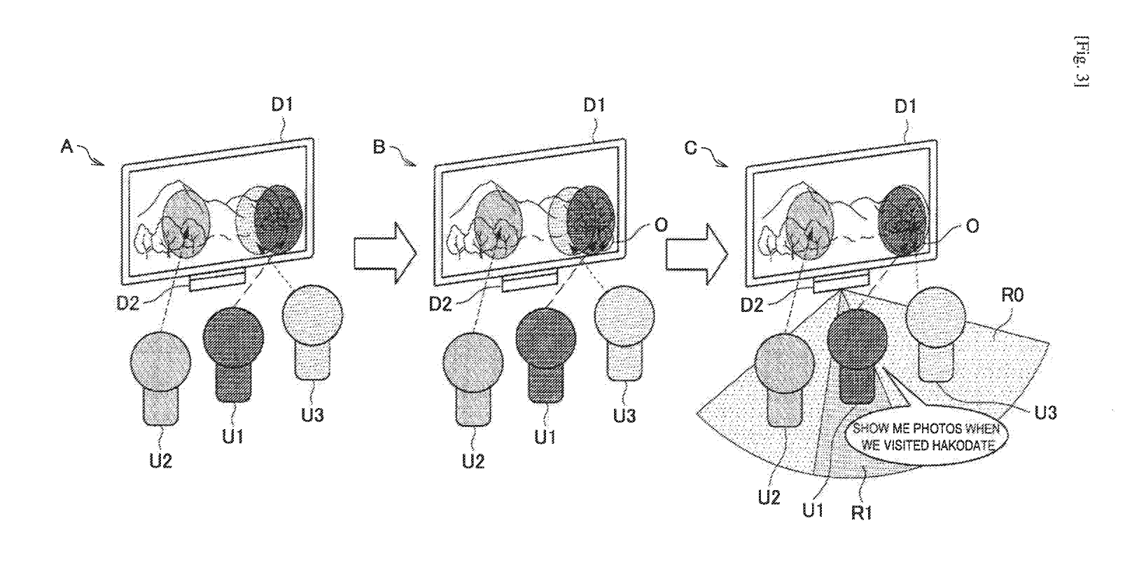

FIG. 3 is an explanatory view illustrating an example of processing according to the information processing method according to an embodiment and shows an overview when sound source separation is used for voice recognition control processing. D1 shown in FIG. 3 shows an example of a display device caused to display the display screen and D2 shown in FIG. 3 shows an example of the voice input device capable of performing sound source separation. In FIG. 3, an example in which the predetermined object O is a voice recognition icon is shown. Also in FIG. 3, an example in which three users U1 to U3 each view the display screen is shown. R0 shown in C of FIG. 3 shows an example of the region where the voice input device D2 can acquire voice and R1 shown in C of FIG. 3 shows an example of the region where the voice input device D2 acquires voice. In FIG. 3, the flow of processing according to the information processing method according to an embodiment chronologically in the order of A shown in FIG. 3, B shown in FIG. 3, and C shown in FIG. 3.

When each of the users U1 to U3 views the display screen, if, for example, the user U1 views the right edge of the display screen (A shown in FIG. 3), the information processing apparatus according to an embodiment displays the predetermined object O on the display screen (B shown in FIG. 3). The information processing apparatus according to an embodiment displays the predetermined object O on the display screen by performing display control processing according to an embodiment described later.

When the predetermined object O is displayed on the display screen, the information processing apparatus according to an embodiment determines whether the user views the predetermined object O by performing, for example, the processing (determination processing) in (1). In the example shown in B of FIG. 3, the information processing apparatus according to an embodiment determines that the user U1 has viewed the predetermined object O.

If it is determined that the user U1 has viewed the predetermined object O, the information processing apparatus according to an embodiment transmits control instructions based on information about the position of the line of sight of the user corresponding to the user U1 to the voice input device D2 capable of performing sound source separation. Based on the control instructions, the voice input device D2 acquires a voice signal showing voice uttered by the position of the user determined to have viewed the predetermined object (C in FIG. 3). Then, the information processing apparatus according to an embodiment acquires the voice signal from the voice input device D2.

When the voice signal is acquired from the voice input device D2, the information processing apparatus according to an embodiment performs processing (described later) related to voice recognition on the voice signal and executes instructions recognized as a result of the processing related to voice recognition.

When sound source separation is used, the information processing apparatus according to an embodiment performs, for example, processing shown with reference to FIG. 3 as the processing according to the information processing method according to an embodiment. It is needless to say that the example of processing according to the information processing method according to an embodiment when the sound source separation is used is not limited to the example shown with reference to FIG. 3.

(2-2) Second Example of the Voice Recognition Control Processing: When the Sound Source Localization is Used

The information processing apparatus according to an embodiment causes voice recognition in cooperation with a voice input device capable of performing sound source localization. The voice input device capable of performing sound source localization according to an embodiment may be, for example, a voice input device included in the information processing apparatus according to an embodiment or a voice input device outside the information processing apparatus according to an embodiment.

The information processing apparatus according to an embodiment selectively causes voice recognition of a voice signal acquired by a voice input device capable of performing sound source localization and showing voice based on, for example, a difference between the position of the user based on information about the position of the line of sight of the user corresponding to the user determined to have viewed a predetermined object and the position of the sound source measured by the voice input device capable of performing sound source localization.

More specifically, when a difference between the position of the user based on information about the position of the line of sight of the user and the position of the sound source is equal to a set threshold or less (or the difference between the position of the user based on information about the position of the line of sight of the user and the position of the sound source is less than the threshold. This also applies below), the information processing apparatus according to an embodiment selectively causes voice recognition of the voice signal. The threshold related to the voice recognition control processing according to the second example may be, for example, a preset fixed value and a variable value that can be changed based on a user operation or the like.

The information processing apparatus according to an embodiment uses, for example, information (data) showing the position of the sound source transmitted from a voice input device capable of performing sound source localization when appropriate. When it is determined that, for example, the user views a predetermined object in the processing (determination processing) in (1), the information processing apparatus according to an embodiment transmits instructions to request transmission of information showing the position of the sound source to a voice input device capable of performing sound source localization so that information showing the position of the sound source transmitted from the voice input device in accordance with the instructions can be used.

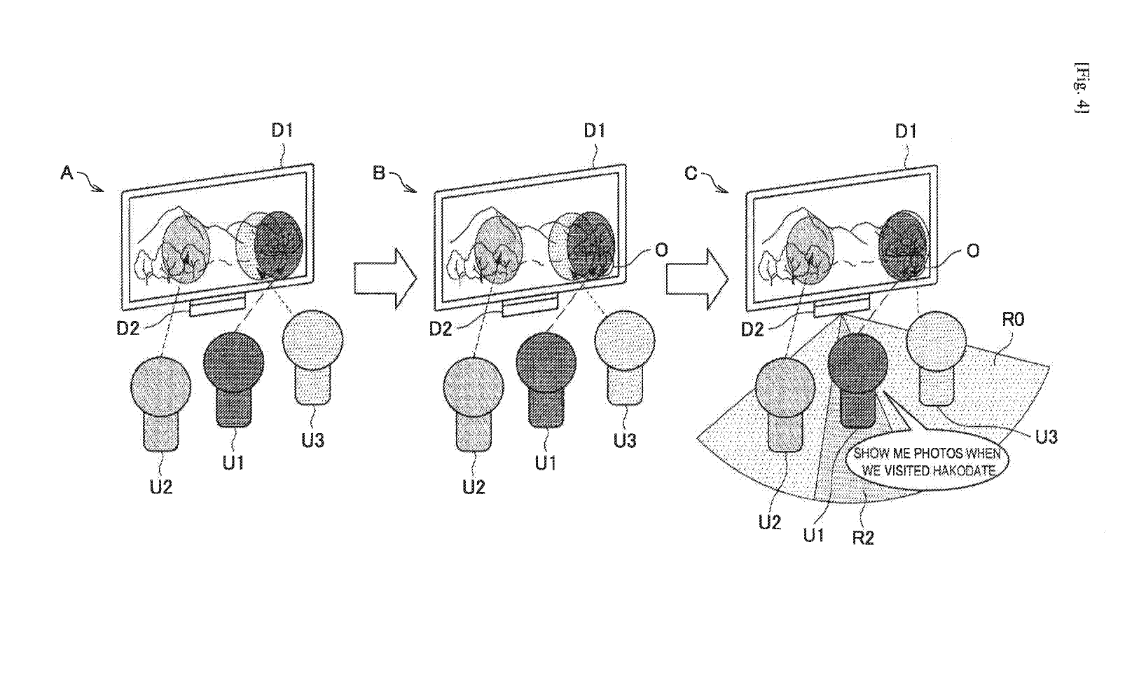

FIG. 4 is an explanatory view illustrating an example of processing according to the information processing method according to an embodiment and shows an overview when sound source localization is used for voice recognition control processing. D1 shown in FIG. 4 shows an example of the display device caused to display the display screen and D2 shown in FIG. 4 shows an example of the voice input device capable of performing sound source localization. In FIG. 4, an example in which the predetermined object O is a voice recognition icon is shown. Also in FIG. 4, an example in which three users U1 to U3 each view the display screen is shown. R0 shown in C of FIG. 4 shows an example of the region where the voice input device D2 can perform sound source localization and R2 shown in C of FIG. 4 shows an example of the position of the sound source identified by the voice input device D2. In FIG. 4, the flow of processing according to the information processing method according to an embodiment chronologically in the order of A shown in FIG. 4, B shown in FIG. 4, and C shown in FIG. 4.

When each of the users U1 to U3 views the display screen, if, for example, the user U1 views the right edge of the display screen (A shown in FIG. 4), the information processing apparatus according to an embodiment displays the predetermined object O on the display screen (B shown in FIG. 4). The information processing apparatus according to an embodiment displays the predetermined object O on the display screen by performing the display control processing according to an embodiment described later.

When the predetermined object O is displayed on the display screen, the information processing apparatus according to an embodiment determines whether the user views the predetermined object O by performing, for example, the processing (determination processing) in (1). In the example shown in B of FIG. 4, the information processing apparatus according to an embodiment determines that the user U1 has viewed the predetermined object O.

If it is determined that the user U1 has viewed the predetermined object O, the information processing apparatus according to an embodiment calculates a difference between the position of the user based on information about the position of the line of sight of the user corresponding to the user determined to have viewed the predetermined object and the position of the sound source measured by the voice input device capable of performing sound source localization. The position of the user based on information about the position of the line of sight of the user according to an embodiment and the position of the sound source measured by the voice input device are represented by, for example, the angle with the display screen. Incidentally, the position of the user based on information about the position of the line of sight of the user according to an embodiment and the position of the sound source measured by the voice input device may be represented by coordinates of a three-dimensional coordinate system including two axes showing a plane corresponding to the display screen and one axis showing the direction perpendicular to the display screen.

When, for example, the calculated difference is equal to a set threshold or less, the information processing apparatus according to an embodiment performs processing (described later) related to voice recognition on a voice signal acquired by the voice input device D2 capable of performing sound source localization and showing voice. Then, the information processing apparatus according to an embodiment executes instructions recognized as a result of the processing related to voice recognition.

When the sound source localization is used, the information processing apparatus according to an embodiment performs, for example, processing as shown with reference to FIG. 4 as the processing according to the information processing method according to an embodiment. It is needless to say that the example of processing according to the information processing method according to an embodiment when the sound source localization is used is not limited to the example shown with reference to FIG. 4.

The information processing apparatus according to an embodiment causes voice recognition by using, as shown in, for example, the voice recognition control processing according to the first example shown in (2-1) or the voice recognition control processing according to the second example shown in (2-2), the sound source separation or sound source localization.

Next, processing related to voice recognition in the information processing apparatus according to an embodiment will be described.

The information processing apparatus according to an embodiment recognizes all instructions that can be recognized from an acquired voice signal regardless of the predetermined object determined to have been viewed by the user in the processing (determination processing) in (1). Then, the information processing apparatus according to an embodiment executes recognized instructions.

However, instructions recognized in the processing related to voice recognition according to an embodiment are not limited to the above instructions.

For example, the information processing apparatus according to an embodiment can exercise control to dynamically change instructions to be recognized based on the predetermined object determined to have been viewed by the user in the processing (determination processing) in (1). Like, for example, the target for controlling voice recognition processing described above, the information processing apparatus according to an embodiment selects the local apparatus, a communication unit (described later), or an external apparatus that can communicate via a connected external communication device as a control target of control that dynamically changes instructions to be recognized. More specifically, as shown in, for example, (A) and (B) below, the information processing apparatus according to an embodiment exercises control to dynamically change instructions to be recognized.

### (A) First Example of Dynamically Changing Instructions to be Recognized in Processing Related to Voice Recognition According to an Embodiment

The information processing apparatus according to an embodiment exercises control so that instructions corresponding to the predetermined object determined to have been viewed by the user in the processing (determination processing) in (1) are recognized.

(A-1)

If the control target of control that dynamically changes instructions to be recognized is the local apparatus, the information processing apparatus according to an embodiment identifies instructions (or an instruction group) corresponding to the determined predetermined object based on a table (or a database) in which objects and instructions (instructions groups) are associated and the determined predetermined object. Then, the information processing apparatus according to an embodiment recognizes instructions corresponding to the predetermined object by recognizing the identified instructions from the acquired voice signal.

(A-2)

If the control target of control that dynamically changes instructions to be recognized is the external apparatus, the information processing apparatus according to an embodiment causes the communication unit (described later) or the like to transmit control data containing, for example, an “instruction to dynamically change instructions to be recognized” and information indicating an object corresponding to the predetermined object to the external apparatus. As the information indicating an object according to an embodiment, for example, the ID indicating an object or data indicating an object can be cited. The control data may further contain, for example, a voice signal showing voice uttered by the user. The external apparatus having acquired the control data recognizes instructions corresponding to the predetermined object by performing processing similar to, for example, the processing of the information processing apparatus according to an embodiment shown in (A-1).

### (B) Second Example of Dynamically Changing Instructions to be Recognized in Processing Related to Voice Recognition According to an Embodiment

The information processing apparatus according to an embodiment exercises control so that instructions corresponding to other objects contained in a region on the display screen containing a predetermined object determined to have been viewed by the user in the processing (determination processing) in (1) are recognized. Also, the information processing apparatus according to an embodiment may further perform, in addition to the recognition of instructions corresponding to the predetermined object as shown in (A), the processing in (B).

As the region on the display screen containing a predetermined object according to an embodiment, for example, a region larger than the first region according to an embodiment can be cited. As an example, for example, a circular region around a reference point of a predetermined object, a rectangular region, or a divided region can be cited as a region on the display screen containing a predetermined object according to an embodiment.

(B-1)

If the control target of control that dynamically changes instructions to be recognized is the local apparatus, the information processing apparatus according to an embodiment determines, for example, among objects whose reference position is contained in a region on the display screen in which a predetermined object according to an embodiment is contained, objects other than the predetermined object as other objects. However, the method of determining other objects according to an embodiment is not limited to the above method. For example, the information processing apparatus according to an embodiment may determine, among objects at least a portion of which is displayed in a region on the display screen in which a predetermined object according to an embodiment is contained, objects other than the predetermined object as other objects.

The information processing apparatus according to an embodiment identifies instructions (or an instruction group) corresponding to other objects based on a table (or a database) in which objects and instructions (instructions groups) are associated and the determined other objects. The information processing apparatus according to an embodiment may further identify instructions (or an instruction group) corresponding to the determined predetermined object based on, for example, the table (or the database) and the determined predetermined object. Then, the information processing apparatus according to an embodiment recognizes instructions corresponding to the other objects (or further instructions corresponding to the predetermined object) by recognizing the identified instructions from the acquired voice signal.

(B-2)

If the control target of control that dynamically changes instructions to be recognized is the external apparatus, the information processing apparatus according to an embodiment causes the communication unit (described later) or the like to transmit control data containing, for example, an “instruction to dynamically change instructions to be recognized” and information indicating object corresponding to other objects to the external apparatus. The control data may further contain, for example, a voice signal showing voice uttered by the user or information showing an object corresponding to a predetermined object. The external apparatus having acquired the control data recognizes instructions corresponding to the other objects (or further, instructions corresponding to the predetermined object) by performing processing similar to, for example, the processing of the information processing apparatus according to an embodiment shown in (B-1).

The information processing apparatus according to an embodiment performs, for example, the above processing as voice recognition control processing according to an embodiment.

However, the voice recognition control processing according to an embodiment is not limited to the above processing.

For example, if, after it is determined that the user has viewed a predetermined object in the processing (determination processing) in (1), it is determined that the user does not view the predetermined object, the information processing apparatus according to an embodiment terminates voice recognition of the user determined to have viewed the predetermined object.

The information processing apparatus according to an embodiment performs, for example, the processing (determination processing) in (1) and the processing (voice recognition control processing) in (2) as the processing according to the information processing method according to an embodiment.

When it is determined that a predetermined object has been viewed in the processing (determination processing) in (1), the information processing apparatus according to an embodiment performs the processing (voice recognition control processing) in (2). That is, the user can cause the information processing apparatus according to an embodiment to start voice recognition by, for example, viewing a predetermined object by directing the line of sight toward the predetermined object. Even if, as described above, the user should be engaged in another operation or a conversation, the possibility that the other operation or the conversation is prevented by a predetermined object being viewed by the user is lower than when voice recognition is performed by a specific user operation or utterance of a specific word. Also, as described above, a predetermined object displayed on the display screen being viewed by the user is considered to be an operation more natural than the specific user operation or utterance of the specific word.

Therefore, the information processing apparatus according to an embodiment can enhance the convenience of the user when voice recognition is performed by performing, for example, the processing (determination processing) in (1), the information processing apparatus according to an embodiment performs the processing (voice recognition control processing) in (2) as the processing according to the information processing method according to an embodiment.

However, the processing according to the information processing method according to an embodiment is not limited to the processing (determination processing) in (1), the information processing apparatus according to an embodiment performs the processing (voice recognition control processing) in (2).

For example, the information processing apparatus according to an embodiment can also perform processing (display control processing) that causes the display screen to display a predetermined object according to an embodiment. Thus, next, the display control processing according to an embodiment will be described.

(3) Display Control Processing

The information processing apparatus according to an embodiment causes the display screen to display a predetermined object according to an embodiment. More specifically, the information processing apparatus according to an embodiment performs, for example, processing of display control processing according to a first example to display control processing according to a fourth example shown below.

(3-1) First Example of the Display Control Processing

The information processing apparatus according to an embodiment causes the display screen to display a predetermined object in, for example, a position set on the display screen. That is, regardless of the position of the line of sight indicated by information about the position of the line of sight of the user, the information processing apparatus according to an embodiment causes the display screen to display a predetermined object in the set position independently of the position of the line of sight indicated by information about the position of the line of sight of the user.

The information processing apparatus according to an embodiment causes the display screen to typically display a predetermined object. The information processing apparatus according to an embodiment can also cause the display screen to selectively display the predetermined object based on a user operation other than the operation by the line of sight.

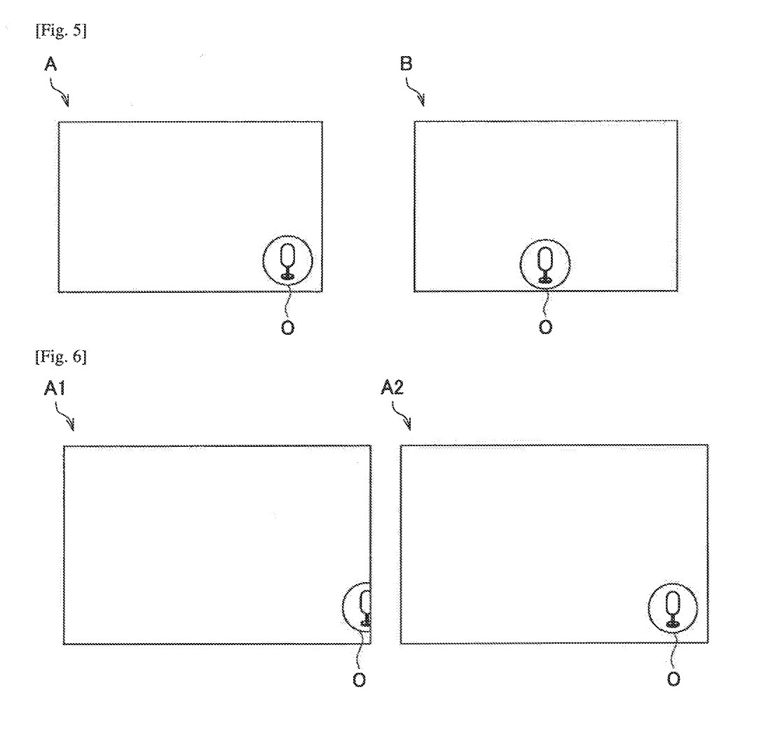

FIG. 5 is an explanatory view illustrating an example of processing according to the information processing method according to an embodiment and shows an example of the display position of the predetermined object O displayed by the display control processing according to an embodiment. In FIG. 5, an example in which the predetermined object O is a voice recognition icon is shown.

As examples of the position where the predetermined object is displayed, various positions, for example, the position at a screen edge of the display screen as shown in A of FIG. 5, the position in the center of the display screen as shown in B of FIG. 5, the positions where objects represented by reference signs O1 to O3 in FIG. 1 are displayed can be cited. However, the position where a predetermined object is displayed is not limited to the examples in FIGS. 1 and 5 and may be any position of the display screen.

(3-2) Second Example of the Display Control Processing

The information processing apparatus according to an embodiment causes the display screen to selectively display a predetermined object based on information about the position of the line of sight of the user.

More specifically, when, for example, the position of the line of sight indicated by information about the position of the line of sight of the user is contained in a set region, the information processing apparatus according to an embodiment causes the display screen to display a predetermined object. If a predetermined object is displayed when the position of the line of sight indicated by information about the position of the line of sight of the user is contained in the set region, the predetermined object is displayed by the set region being viewed once by the user.

As the region in the display control processing according to an embodiment, for example, the minimum region of regions containing a predetermined object (that is, regions in which the predetermined object is displayed), a circular region around the reference point of a predetermined object, a rectangular region, and a divided region can be cited.

However, the display control processing according to the second example is not limited to the above processing.

For example, when the display screen is caused to display a predetermined object, the information processing apparatus according to an embodiment may cause the display screen to stepwise display the predetermined object based on the position of the line of sight indicated by information about the position of the line of sight of the user. For example, the information processing apparatus according to an embodiment causes the display screen to display the predetermined object in accordance with the time in which the position of the line of sight indicated by information about the position of the line of sight of the user is contained in the set region.

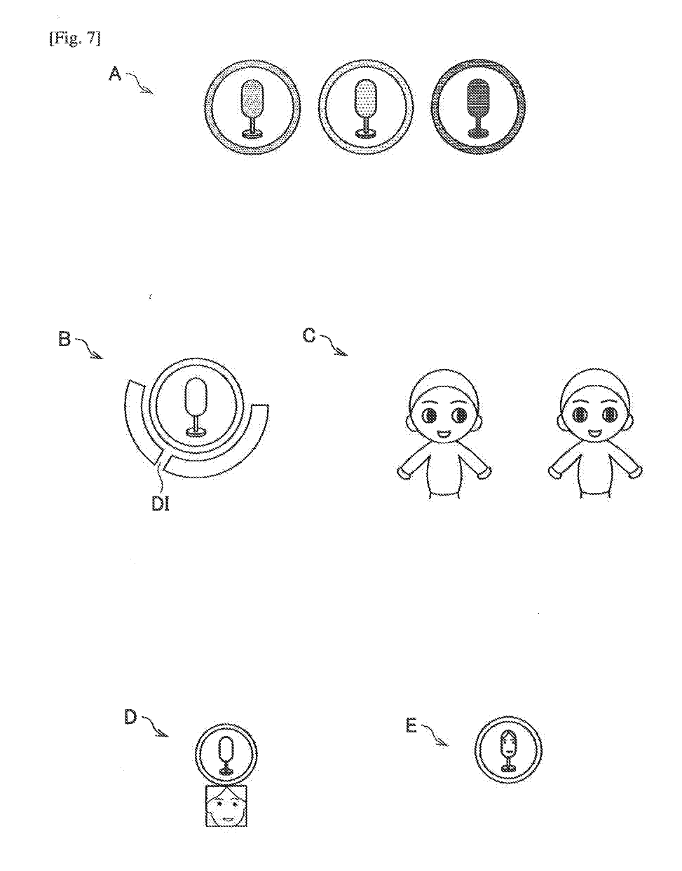

FIG. 6 is an explanatory view illustrating an example of processing according to the information processing method according to an embodiment and shows an example of the predetermined object O displayed stepwise by the display control processing according to an embodiment. In FIG. 6, an example in which the predetermined object O is a voice recognition icon is shown.

When, for example, the time in which the position of the line of sight indicated by information about the position of the line of sight of the user is contained in the set region is equal to a first time or longer (or the time contained in the set region is longer than the first time), the information processing apparatus according to an embodiment causes the display screen to display a portion of the predetermined object O (A shown in FIG. 6). For example, the information processing apparatus according to an embodiment causes the display screen to display a portion of the predetermined object O in the position corresponding to the position of the line of sight indicated by information about the position of the line of sight of the user.

As the first time according to an embodiment, for example, a set fixed time can be cited.

The information processing apparatus according to an embodiment may dynamically change the first time based on the number of pieces of acquired information about the position of the line of sight of the users (that is, the number of users). The information processing apparatus according to an embodiment sets, for example, a longer first time with an increasing number of users. With the first time being dynamically set in accordance with the number of users, for example, one user can be prevented from accidentally causing the display screen to display the predetermined object.

When, as shown in, for example, A of FIG. 6, a portion of the predetermined object O is displayed on the display screen, if the time in which the position of the line of sight indicated by information about the position of the line of sight of the user is contained in the set region after the portion of the predetermined object O is displayed on the display screen is equal to a second time or longer (or the time contained in the set region is longer than the second time), the information processing apparatus according to an embodiment causes the display screen to display the whole predetermined object O (B shown in FIG. 6).

As the second time according to an embodiment, for example, a set fixed time can be cited.

Like the first time, the information processing apparatus according to an embodiment may dynamically change the second time based on the number of pieces of acquired information about the position of the line of sight of the users (that is, the number of users). With the second time being dynamically set in accordance with the number of users, for example, one user can be prevented from accidentally causing the display screen to display the predetermined object.

When the display screen is caused to display a predetermined object, the information processing apparatus according to an embodiment may cause the display screen to display the predetermined object by using a set display method.

As the set display method according to an embodiment, for example, the slide-in and fade-in can be cited.

The information processing apparatus according to an embodiment can also change the set display method according to an embodiment dynamically based on, for example, information about the position of the line of sight of the user.

As an example, the information processing apparatus according to an embodiment identifies the direction (for example, up and down or left and right) of movement of eyes based on information about the position of the line of sight of the user. Then, the information processing apparatus according to an embodiment causes the display screen to display a predetermined object by using a display method by which the predetermined object appears from the direction corresponding to the identified direction of movement of eyes. The information processing apparatus according to an embodiment may further change the position where the predetermined object appears in accordance with the position of the line of sight indicated by information about the position of the line of sight of the user.

(3-3) Third Example of the Display Control Processing

When voice recognition is performed by, for example, the processing (voice recognition control processing) in (2), the information processing apparatus according to an embodiment changes a display mode of a predetermined object. The state of processing according to the information processing method according to an embodiment can be fed back to the user by the display mode of the predetermined object being changed by the information processing apparatus according to an embodiment.

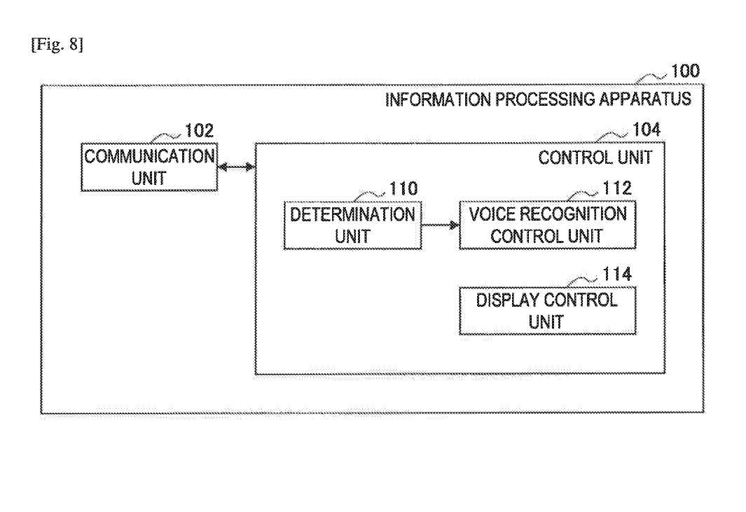

FIG. 7 is an explanatory view illustrating an example of processing according to the information processing method according to an embodiment and shows an example of the display mode of a predetermined object according to an embodiment. A of FIG. 7 to E of FIG. 7 each show examples of the display mode of the predetermined object according to an embodiment.

The information processing apparatus according to an embodiment changes, as shown in, for example, A of FIG. 7, the color of the predetermined object or the color in which the predetermined object shines in accordance with the user determined to have viewed the predetermined object in the processing (determination processing) in (1). With the color of the predetermined object or the color in which the predetermined object shines being changed, the user determined to have viewed the predetermined object in the processing (determination processing) in (1) can be fed back to one or two or more users viewing the display screen.

When, for example, the user ID is recognized in the processing (determination processing) in (1), the information processing apparatus according to an embodiment causes the display screen to display the predetermined object in the color corresponding to the user ID or the predetermined object shining in the color corresponding to the user ID. The information processing apparatus according to an embodiment may also cause the display screen to display the predetermined object in a different color or the predetermined object shining in a different color, for example, each time it is determined that the predetermined object has been viewed by the processing (determination processing) in (1).

As shown in, for example, B of FIG. 7 and C of FIG. 7, the information processing apparatus according to an embodiment may visually show the direction of voice recognized by the processing (voice recognition control processing) in (2). With the direction of the recognized voice visually being shown, the direction of voice recognized by the information processing apparatus according to an embodiment can be fed back to one or two or more users viewing the display screen.

In the example shown in B of FIG. 7, as shown by reference sign D1 shown in B of FIG. 7, the direction of the recognized voice is indicated by a bar in which the portion of the voice direction is vacant. In the example shown in C of FIG. 7, the direction of the recognized voice is indicated by a character image (example of a voice recognition image) viewing in the direction of the recognized voice.

As shown in, for example, D of FIG. 7 and E of FIG. 7, the information processing apparatus according to an embodiment may show a captured image corresponding to the user determined to have viewed the predetermined object in the processing (determination processing) in (1) together with a voice recognition icon. With the captured image being shown together with the voice recognition icon, the user determined to have viewed the predetermined object in the processing (determination processing) in (1) can be fed back to one or two or more users viewing the display screen.

The example shown in D of FIG. 7 shows an example a captured image is displayed side by side with a voice recognition icon. The example shown in E of FIG. 7 shows an example in which a captured image is displayed by being combined with a voice recognition icon.

As shown in, for example, FIG. 7, the information processing apparatus according to an embodiment gives feedback of the state of processing according to the information processing method according to an embodiment to the user by changing the display mode of the predetermined object.

However, the display control processing according to the third example is not limited to the example shown in FIG. 7. For example, when the user ID is recognized in the processing (determination processing) in (1), the information processing apparatus according to an embodiment may cause the display screen to display an object (for example, a voice recognition image such as a voice recognition icon or character image) corresponding to the user ID.

(3-4) Fourth Example of the Display Control Processing

The information processing apparatus according to an embodiment can perform processing by, for example, combining the display control processing according to the first example or the display control processing according to the second example and the display control processing according to the third example.

### Information Processing Apparatus According to an Embodiment

Next, an example of the configuration of an information processing apparatus according to an embodiment capable of performing the processing according to the information processing method according to an embodiment described above will be described.

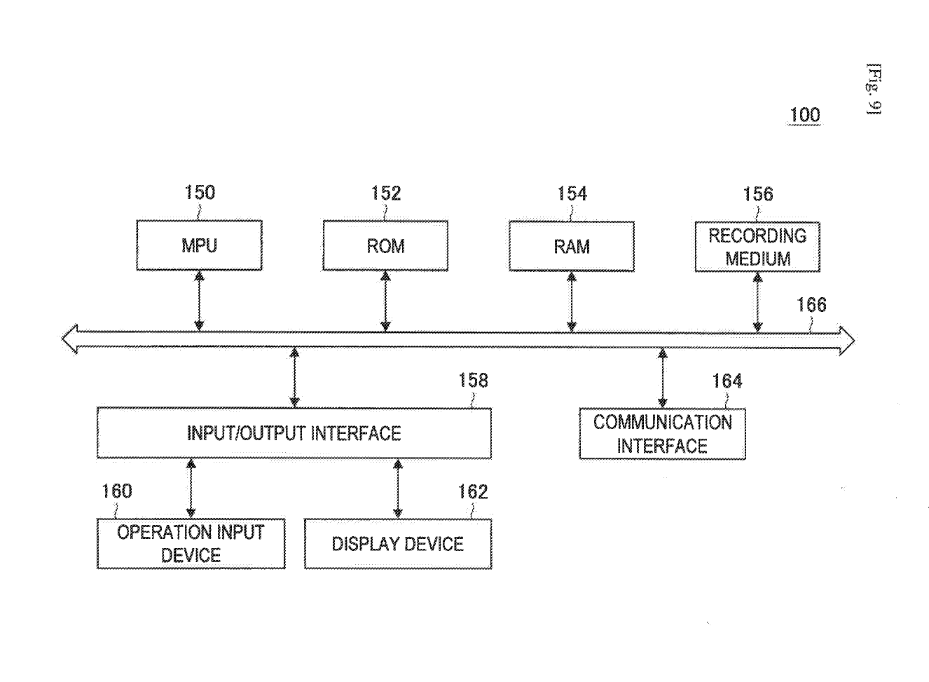

FIG. 8 is a block diagram showing an example of the configuration of an information processing apparatus 100 according to an embodiment. The information processing apparatus 100 includes, for example, a communication unit 102 and a control unit 104.

The information processing apparatus 100 may also include, for example, a ROM (Read Only Memory, not shown), a RAM (Random Access Memory, not shown), a storage unit (not shown), an operation unit (not shown) that can be operated by the user, and a display unit (not shown) that displays various screens on the display screen. The information processing apparatus 100 connects each of the above elements by, for example, a bus as a transmission path.

The ROM (not shown) stores programs used by the control unit 104 and control data such as operation parameters. The RAM (not shown) temporarily stores programs executed by the control unit 104 and the like.

The storage unit (not shown) is a storage means included in the information processing apparatus 100 and stores, for example, data related to the information processing method according to an embodiment such as data indicating various objects displayed on the display screen and various kinds of data such as applications. As the storage unit (not shown), for example, a magnetic recording medium such as a hard disk and a nonvolatile memory such as a flash memory can be cited. The storage unit (not shown) may be removable from the information processing apparatus 100.

As the operation unit (not shown), an operation input device described later can be cited. As the display unit (not shown), a display device described later can be cited.

(Hardware Configuration Example of the Information Processing Apparatus 100)

FIG. 9 is an explanatory view showing an example of the hardware configuration of the information processing apparatus 100 according to an embodiment. The information processing apparatus 100 includes, for example, an MPU 150, a ROM 152, a RAM 154, a recording medium 156, an input/output interface 158, an operation input device 160, a display device 162, and a communication interface 164. The information processing apparatus 100 connects each structural element by, for example, a bus 166 as a transmission path of data.

The MPU 150 is constituted of a processor such as a MPU (Micro Processing Unit) and various processing circuits and functions as the control unit 104 that controls the whole information processing apparatus 100. The MPU 150 also plays the role of, for example, a determination unit 110, a voice recognition control unit 112, and a display control unit 114 described later in the information processing apparatus 100.

The ROM 152 stores programs used by the MPU 150 and control data such as operation parameters. The RAM 154 temporarily stores programs executed by the MPU 150 and the like.

The recording medium 156 functions as a storage unit (not shown) and stores, for example, data related to the information processing method according to an embodiment such as data indicating various objects displayed on the display screen and various kinds of data such as applications. As the recording medium 156, for example, a magnetic recording medium such as a hard disk and a nonvolatile memory such as a flash memory can be cited. The recording medium 156 may be removable from the information processing apparatus 100.

The input/output interface 158 connects, for example, the operation input device 160 and the display device 162. The operation input device 160 functions as an operation unit (not shown) and the display device 162 functions as a display unit (not shown). As the input/output interface 158, for example, a USB (Universal Serial Bus) terminal, a DVI (Digital Visual Interface) terminal, an HDMI (High-Definition Multimedia Interface) (registered trademark) terminal, and various processing circuits can be cited. The operation input device 160 is, for example, included in the information processing apparatus 100 and connected to the input/output interface 158 inside the information processing apparatus 100. As the operation input device 160, for example, a button, a direction key, a rotary selector such as a jog dial, and a combination of these devices can be cited. The display device 162 is, for example, included in the information processing apparatus 100 and connected to the input/output interface 158 inside the information processing apparatus 100. As the display device 162, for example, a liquid crystal display and an organic electro-luminescence display (also called an OLED display (Organic Light Emitting Diode Display)) can be cited.

It is needless to say that the input/output interface 158 can also be connected to an external device such as an operation input device (for example, a keyboard and a mouse) and a display device as an external apparatus of the information processing apparatus 100. The display device 162 may be a device capable of both the display and user operations like, for example, a touch screen.

The communication interface 164 is a communication means included in the information processing apparatus 100 and functions as the communication unit 102 to communicate with an external device or an external apparatus such as an external imaging device, an external display device, and an external sensor via a network (or directly) wirelessly or through a wire. As the communication interface 164, for example, a communication antenna and RF (Radio Frequency) circuit (wireless communication), an IEEE802.15.1 port and transmitting/receiving circuit (wireless communication), an IEEE802.11 port and transmitting/receiving circuit (wireless communication), and a LAN (Local Area Network) terminal and transmitting/receiving circuit (wire communication) can be cited. As the network according to an embodiment, for example, a wire network such as LAN and WAN (Wide Area Network), a wireless network such as wireless LAN (WLAN: Wireless Local Area Network) and wireless WAN (WWAN: Wireless Wide Area Network) via a base station, and the Internet using the communication protocol such as TCP/IP (Transmission Control Protocol/Internet Protocol) can be cited.

With the configuration shown in, for example, FIG. 9, the information processing apparatus 100 performs processing according to the information processing method according to an embodiment. However, the hardware configuration of the information processing apparatus 100 according to an embodiment is not limited to the configuration shown in FIG. 9.

The information processing apparatus 100 may include, for example, an imaging device playing the role of an imaging unit (not shown) that captures moving images or still images. When an imaging device is included, for example, the information processing apparatus 100 can obtain information about a position of a line of sight of the user by processing a captured image generated by imaging in the imaging device. Also when an imaging device is included, for example, the information processing apparatus 100 can execute processing for identifying the user by using a captured image generated by imaging in the imaging device and use the captured image (or a portion thereof) as an object.

As the imaging device according to an embodiment, for example, a lens/image sensor and a signal processing circuit can be cited. The lens/image sensor is constituted of, for example, an optical lens and an image sensor using a plurality of image sensors such as CMOS (Complementary Metal Oxide Semiconductor). The signal processing circuit includes, for example, an AGC (Automatic Gain Control) circuit or an ADC (Analog to Digital Converter) to convert an analog signal generated by the image sensor into a digital signal (image data). The signal processing circuit may also perform various kinds of signal processing, for example, the white balance correction processing, tone correction processing, gamma correction processing, YCbCr conversion processing, and edge enhancement processing.

The information processing apparatus 100 may further include, for example, a sensor plating the role of a detection unit (not shown) that obtains data that can be used to identify the position of the line of sight of the user according to an embodiment. When such a sensor is included, the information processing apparatus 100 can improve the estimation accuracy of the position of the line of sight of the user by using, for example, data obtained from the sensor.

As the sensor according to an embodiment, for example, any sensor that obtains detection values that can be used to improve the estimation accuracy of the position of the line of sight of the user such as an infrared ray sensor can be cited.

When configured to, for example, perform processing on a standalone basis, the information processing apparatus 100 may not include the communication interface 164.

The information processing apparatus 100 may also be configured not to include the recording medium 156, the operation device 160, or the display device 162.

Referring to FIG. 8, an example of the configuration of the information processing apparatus 100 will be described. The communication unit 102 is a communication means included in the information processing apparatus 100 and communicates with an external device or an external apparatus such as an external imaging device, an external display device, and an external sensor via a network (or directly) wirelessly or through a wire. Communication of the communication unit 102 is controlled by, for example, the control unit 104.

As the communication unit 102, for example, a communication antenna and RF circuit and a LAN terminal and transmitting/receiving circuit can be cited, but the configuration of the communication unit 102 is not limited to the above example. For example, the communication unit 102 may adopt a configuration conforming to any standard capable of communication such as a USB terminal and transmitting/receiving circuit or any configuration capable of communicating with an external apparatus via a network.

The control unit 104 is configured by, for example, an MPU and plays the role of controlling the whole information processing apparatus 100. The control unit 104 includes, for example, the determination unit 110, the voice recognition control unit 112, and a display control unit 114 and plays a leading role of performing the processing according to the information processing method according to an embodiment.

The determination unit 110 plays a leading role of performing the processing (determination processing) in (1).

For example, the determination unit 110 determines whether the user has viewed a predetermined object based on information about the position of the line of sight of the user. More specifically, the determination unit 110 performs, for example, the determination processing according to the first example shown in (1-1).

The determination unit 110 can also determine that after it is determined that the user has viewed the predetermined object, the user does not view the predetermined object based on, for example, information about the position of the line of sight of the user.

More specifically, the determination unit 110 performs, for example, the determination processing according to the second example shown in (1-2) or the determination processing according to the third example shown in (1-3).

The determination unit 110 may also perform, for example, the determination processing according to the fourth example shown in (1-4) or the determination processing according to the fifth example shown in (1-5).

The voice recognition control unit 112 plays a leading role of performing the processing (voice recognition control processing) in (2).

When, for example, the user is determined to have viewed the predetermined object by the determination unit 110, the voice recognition control unit 112 controls voice recognition processing to cause voice recognition. More specifically, the voice recognition control unit 112 performs, for example, the voice recognition control processing according to the first example shown in (2-1) or the voice recognition control processing according to the second example shown in (2-2).

When, after it is determined that the user has viewed the predetermined object, the determination unit 110 determines that the user does not view the predetermined object, the voice recognition control unit 112 terminates voice recognition of the user determined to have viewed the predetermined object.

The display control unit 114 plays a leading role of performing the processing (display control processing) in (3) and causes the display screen to display a predetermined object according to an embodiment. More specifically, the display control unit 114 performs, for example, the display control processing according to the first example shown in (3-1), the display control processing according to the second example shown in (3-2), or the display control processing according to the third example shown in (3-3).

By including, for example, the determination unit 110, the voice recognition control unit 112, and a display control unit 114, the control unit 104 leads the processing according to the information processing method according to an embodiment.

With the configuration shown in, for example, FIG. 8, the information processing apparatus 100 performs the processing (for example, the processing (determination processing) in (1) to the processing (display control processing) in (3)) according to the information processing method according to an embodiment.

Therefore, with the configuration shown in, for example, FIG. 8, the information processing apparatus 100 can enhance the convenience of the user when voice recognition is performed.

Also with the configuration shown in, for example, FIG. 8, the information processing apparatus 100 can achieve effects that can be achieved by, for example, the above processing according to the information processing method according to an embodiment being performed.

However, the configuration of the information processing apparatus according to an embodiment is not limited to the configuration in FIG. 8.

For example, the information processing apparatus according to an embodiment can include one or two or more of the determination unit 110, the voice recognition control unit 112, and a display control unit 114 shown in FIG. 8 separately from the control unit 104 (for example, realized by a separate processing circuit).

The information processing apparatus according to an embodiment can also be configured not to include the display control unit 114 shown in FIG. 8. Even if configured not to include the display control unit 114, the information processing apparatus according to an embodiment can perform the processing (determination processing) in (1) and the processing (voice recognition control processing) in (2). Therefore, even if configured not to include the display control unit 114, the information processing apparatus according to an embodiment can enhance the convenience of the user when voice recognition is performed.

The information processing apparatus according to an embodiment may not include the communication unit 102 when communicating with an external device or an external apparatus via an external communication device having the function and configuration similar to those of the communication unit 102 or when configured to perform processing on a standalone basis.

The information processing apparatus according to an embodiment may further include, for example, an imaging unit (not shown) configured by an imaging device. When an imaging unit (not shown) is included, the information processing apparatus according to an embodiment can obtain information about a position of a line of sight of the user by processing a captured image generated by imaging in the imaging unit (not shown). Also when an imaging unit (not shown) is included, for example, the information processing apparatus according to an embodiment can execute processing for identifying the user by using a captured image generated by imaging in the imaging unit (not shown), and use the captured image (or a portion thereof) as an object.

The information processing apparatus according to an embodiment may further include, for example, a detection unit (not shown) configured by any sensor that obtains detection values that can be used to improve the estimation accuracy of the position of the line of sight of the user. When a detection unit (not shown) is included, the information processing apparatus according to an embodiment can improve the estimation accuracy of the position of the line of sight of the user by using, for example, data obtained from the detection unit (not shown).

In the foregoing, the information processing apparatus has been described as an embodiment, but an embodiment is not limited to such a form. An embodiment can also be applied to various devices, for example, a TV set, a display apparatus, a tablet apparatus, a communication apparatus such as a mobile phone and smartphone, a video/music playback apparatus (or a video/music recording and playback apparatus), a game machine, and a computer such as a PC (Personal Computer). An embodiment can also be applied to, for example, a processing IC (Integrated Circuit) that can be embedded in devices as described above.

Embodiments may also be realized by a system including a plurality of apparatuses predicated on connection to a network (or communication between each apparatus) like, for example, cloud computing. That is, the above information processing apparatus according to an embodiment can be realized as, for example, an information processing system including a plurality of apparatuses.

### Program According to an Embodiment

The convenience of the user when voice recognition is performed can be enhanced by a program (for example, a program capable of performing processing according to an information processing method according to an embodiment such as the processing (determination processing) in (1), the processing (voice recognition control processing) in (2), and the processing (determination processing) in (1) to the processing (display control processing) in (3)) causing a computer to function as an information processing apparatus according to an embodiment being performed by a processor or the like in the computer.

Also, effects achieved by the above processing according to the information processing method according to an embodiment can be achieved by a program causing a computer to function as an information processing apparatus according to an embodiment being performed by a processor or the like in the computer.

In the foregoing, embodiments of the present disclosure have been described in detail with reference to the accompanying drawings, but the technical scope of the present disclosure is not limited to the above examples. A person skilled in the art may find various alterations and modifications within the scope of the appended claims and it should be understood that they will naturally come under the technical scope of the present disclosure.

For example, the above shows that a program (computer program) causing a computer to function as an information processing apparatus according to an embodiment is provided, but embodiments can further provide a recording medium caused to store the program.

The above configurations show examples of embodiments and naturally come under the technical scope of the present disclosure.

Effects described in this specification are only descriptive or illustrative and are not restrictive. That is, the technology according to the present disclosure can achieve other effects obvious to a person skilled in the art from the description of this specification, together with the above effects or instead of the above effects.

The present technology may be embodied as the following configurations, but is not limited thereto.

(1) An information processing apparatus including:

a circuitry configured to:
initiate a voice recognition upon a determination that a user gaze has been made towards a first region within which a display object is displayed; and
initiate an execution of a process based on the voice recognition.

(2) The information processing apparatus of (1), wherein a direction of the user gaze is determined based on a captured image of the user.

(3) The information processing apparatus of (1) or (2), wherein a direction of the user gaze is determined based on a determined orientation of the face of the user.

(4) The information processing apparatus of any of (1) through (3), wherein a direction of the user gaze is determined based on iris position or pupil position of at least one eye of the user.

(5) The information processing apparatus of any of (1) through (4), wherein the user gaze is attributed to the user, from whom the gaze originates, and who is distinguished from at least one additional viewer.

(6) The information processing apparatus of any of (1) through (5), wherein the circuitry initiates the voice recognition of an audible sound originating from a position of the user from whom the gaze is determined to have originated, the user being selected from a plurality of viewers based upon a characteristic of the gaze.

(7) The information processing apparatus of any of (1) through (6), wherein voice commands uttered by other ones of the plurality of viewers not the user are not executed upon.

(8) The information processing apparatus of any of (1) through (7), wherein the determination that the user gaze has been made towards the first region within which the display object is displayed is made based on information about a position of a line of sight of the user on a screen of a display that displays the display object.

(9) The information processing apparatus of any of (1) through (8), wherein the information about the position of the line of sight of the user includes data indicating or identifying the position of the line of sight of the user.

(10) The information processing apparatus of any of (1) through (9), wherein the circuitry initiates the voice recognition upon a determination that the user gaze has been made towards the first region for a time equal to or longer than a predetermined time.

(11) The information processing apparatus of any of (1) through (10), wherein the determination that the user gaze has been made towards the first region within which the display object is displayed indicates that the user is viewing the display object.

(12) The information processing apparatus of any of (1) through (11), wherein the user is further determined to be no longer viewing the display object when the user gaze is determined to no longer be made towards a second region.

(13) The information processing apparatus of any of (1) through (12), wherein the second region is larger than the first region.

(14) The information processing apparatus of any of (1) through (13), wherein the second region encompasses the first region.

(15) The information processing apparatus of any of (1) through (14), wherein the circuitry initiates the voice recognition of an audible sound originating from a position of the user determined to have gazed towards the first region.

(16) The information processing apparatus of any of (1) through (15), wherein the audible sound is a voice signal.

(17) The information processing apparatus of any of (1) through (16), wherein the first region is a region within a screen of a display.

(18) The information processing apparatus of any of (1) through (17), wherein the circuitry is further configured to initiate the voice recognition only for an audible sound that has originated from a person who made the user gaze towards the first region.

(19) An information processing method including:

initiating a voice recognition upon a determination that a user gaze has been made towards a first region within which a display object is displayed; and
executing a process based on the voice recognition.

(20) A non-transitory computer-readable medium having embodied thereon a program,

which when executed by a computer causes the computer to perform a method, the method including:
initiating a voice recognition upon a determination that a user gaze has been made towards a first region within which a display object is displayed; and
executing a process based on the voice recognition.

Additionally, the present disclosure can also be configured as follows.

(1) An information processing apparatus including:

a determination unit that determines whether a user has viewed a predetermined object based on information about a position of a line of sight of the user on a display screen; and

a voice recognition control unit that controls voice recognition processing when it is determined that the user has viewed the predetermined object.

(2) The information processing apparatus according to (1), wherein the voice recognition control unit exercises control to dynamically change instructions to be recognized based on the predetermined object determined to have been viewed.

(3) The information processing apparatus according to (1) or (2), wherein the voice recognition control unit exercises control to recognize instructions corresponding to the predetermined object determined to have been viewed.

(4) The information processing apparatus according to any one of (1) to (3), wherein the voice recognition control unit exercises control to recognize instructions corresponding to other objects contained in a region on the display screen containing the predetermined object determined to have been viewed.

(5) The information processing apparatus according to any one of (1) to (4), wherein the voice recognition control unit

causes a voice input device capable of performing sound source separation to acquire a voice signal showing voice uttered from a position of the user determined to have viewed the predetermined object based on the information about the position of the line of sight of the user corresponding to the user determined to have viewed the predetermined object and

causes voice recognition of the voice signal acquired by the voice input device.

(6) The information processing apparatus according to any one of (1) to (4), wherein the voice recognition control unit causes,

when a difference between a position of the user based on the information about the position of the line of sight of the user corresponding to the user determined to have viewed the predetermined object and a position of a sound source measured by a voice input device capable of performing sound source localization is equal to a set threshold or less or

when the difference between the position of the user and the position of the sound source is smaller than the threshold,

voice recognition of a voice signal acquired by the voice input device and showing voice.

(7) The information processing apparatus according to any one of (1) to (6), wherein when the position of the line of sight indicated by the information about the position of the line of sight of the user is contained in a first region on the display screen containing the predetermined object, the determination unit determines that the user has viewed the predetermined object.

(8) The information processing apparatus according to any one of (1) to (7), wherein when the determination unit determines that the user has viewed the predetermined object,

the determination unit determines that the user does not view the predetermined object when the position of the line of sight indicated by the information about the position of the line of sight of the user corresponding to the user determined to have viewed the predetermined object is not contained in a second region on the display screen containing the predetermined object and

when it is determined that the user does not view the predetermined object, the voice recognition control unit terminates voice recognition of the user.

(9) The information processing apparatus according to any one of (1) to (7), wherein when the determination unit determines that the user has viewed the predetermined object,

the determination unit

determines that the user does not view the predetermined object when a state in which the position of the line of sight indicated by the information about the position of the line of sight of the user corresponding to the user determined to have viewed the predetermined object is not contained in a second region on the display screen containing the predetermined object continues for a set setting time or longer or

the state in which the position of the line of sight indicated by the information about the position of the line of sight of the user corresponding to the user determined to have viewed the predetermined object is not contained in the second region continues longer than the setting time and

when it is determined that the user does not view the predetermined object, the voice recognition control unit terminates voice recognition of the user.

(10) The information processing apparatus according to (9), wherein the determination unit dynamically sets the setting time based on a history of the position of the line of sight indicated by the information about the position of the line of sight of the user corresponding to the user determined to have viewed the predetermined object.

(11) The information processing apparatus according to any one of (1) to (10), wherein after it is determined that one user has viewed the predetermined object, when it is not determined that the user does not view the predetermined object, the determination unit does not determine that another user has viewed the predetermined object.

(12) The information processing apparatus according to any one of (1) to (11), wherein the determination unit

identifies the user based on a captured image in which a direction in which an image is displayed on the display screen is captured and

determines whether the user has viewed the predetermined object based on the information about the position of the line of sight of the user corresponding to the identified user.

(13) The information processing apparatus according to any one of (1) to (12), further including:

a display control unit causing the display screen to display the predetermined object.

(14) The information processing apparatus according to (13), wherein the display control unit causes the display screen to display the predetermined object in a position set on the display screen regardless of the position of the line of sight indicated by the information about the position of the line of sight of the user.

(15) The information processing apparatus according to (13), wherein the display control unit causes the display screen to selectively display the predetermined object based on the information about the position of the line of sight of the user.

(16) The information processing apparatus according to (15), wherein when the display control unit causes the display screen to display the predetermined object, the display control unit uses a set display method to cause the display screen to display the predetermined object.

(17) The information processing apparatus according to (15) or (16), wherein when the display control unit causes the display screen to display the predetermined object, the display control unit causes the display screen to stepwise display the predetermined object based on the position of the line of sight indicated by the information about the position of the line of sight of the user.

(18) The information processing apparatus according to any one of (13) to (17), wherein when voice recognition is performed, the display control unit changes a display mode of the predetermined object.

(19) An information processing method executed by an information processing apparatus, the method including:

determining whether a user has viewed a predetermined object based on information about a position of a line of sight of the user on a display screen; and

controlling voice recognition processing when it is determined that the user has viewed the predetermined object.

(20) A program causing a computer to execute:

determining whether a user has viewed a predetermined object based on information about a position of a line of sight of the user on a display screen; and

controlling voice recognition processing when it is determined that the user has viewed the predetermined object.

### REFERENCE SIGNS LIST

100 information processing apparatus
102 communication unit
104 control unit
110 determination unit
112 voice recognition control unit
114 display control unit

1. An information processing apparatus comprising:
a circuitry configured to:
initiate a voice recognition upon a determination that a user gaze has been made towards a first region within which a display object is displayed; and
initiate an execution of a process based on the voice recognition.

2. The information processing apparatus according to claim 1, wherein a direction of the user gaze is determined based on a captured image of the user.

3. The information processing apparatus according to claim 1, wherein a direction of the user gaze is determined based on a determined orientation of the face of the user.

4. The information processing apparatus according to claim 1, wherein a direction of the user gaze is determined based on iris position or pupil position of at least one eye of the user.

5. The information processing apparatus according to claim 1, wherein the user gaze is attributed to the user, from whom the gaze originates, and who is distinguished from at least one additional viewer.

6. The information processing apparatus according to claim 1, wherein the circuitry initiates the voice recognition of an audible sound originating from a position of the user from whom the gaze is determined to have originated, the user being selected from a plurality of viewers based upon a characteristic of the gaze.

7. The information processing apparatus according to claim 6, wherein voice commands uttered by other ones of the plurality of viewers not the user are not executed upon.

8. The information processing apparatus according to claim 1, wherein the determination that the user gaze has been made towards the first region within which the display object is displayed is made based on information about a position of a line of sight of the user on a screen of a display that displays the display object.

9. The information processing apparatus according to claim 8, wherein the information about the position of the line of sight of the user comprises data indicating or identifying the position of the line of sight of the user.

10. The information processing apparatus according to claim 1, wherein the circuitry initiates the voice recognition upon a determination that the user gaze has been made towards the first region for a time equal to or longer than a predetermined time.

11. The information processing apparatus according to claim 1, wherein the determination that the user gaze has been made towards the first region within which the display object is displayed indicates that the user is viewing the display object.

12. The information processing apparatus according to claim 11, wherein the user is further determined to be no longer viewing the display object when the user gaze is determined to no longer be made towards a second region.

13. The information processing apparatus according to claim 12, wherein the second region is larger than the first region.

14. The information processing apparatus according to claim 12, wherein the second region encompasses the first region.

15. The information processing apparatus according to claim 1, wherein the circuitry initiates the voice recognition of an audible sound originating from a position of the user determined to have gazed towards the first region.

16. The information processing apparatus according to claim 15, wherein the audible sound is a voice signal.

17. The information processing apparatus according to claim 1, wherein the first region is a region within a screen of a display.

18. The information processing apparatus according to claim 1, wherein the circuitry is further configured to initiate the voice recognition only for an audible sound that has originated from a person who made the user gaze towards the first region.

19. An information processing method comprising:
initiating a voice recognition upon a determination that a user gaze has been made towards a first region within which a display object is displayed; and
executing a process based on the voice recognition.

20. A non-transitory computer-readable medium having embodied thereon a program, which when executed by a computer causes the computer to perform a method, the method comprising:
initiating a voice recognition upon a determination that a user gaze has been made towards a first region within which a display object is displayed; and
executing a process based on the voice recognition.
